(19) United States
(12) Patent Application Publication
(10) Pub. No.: US 2011/0157314 A1
(43) Pub. Date: Jun. 30, 2011

(54) Image Processing Apparatus, Image Processing Method and Recording Medium

(75) Inventor: Takashi Kurino, Yokohama (JP)

(73) Assignee: SAMSUNG ELECTRONICS CO., LTD., Suwon-si (KR)

(21) Appl. No.: 12/978,281

(22) Filed: Dec. 23, 2010

(30) Foreign Application Priority Data
Dec. 24, 2009 (JP) 2009-293471
Dec. 14, 2010 (KR) 10-2010-0127873

(51) Int. Cl. H04N 13/02

(52) U.S. Cl. 348/46; 348/E13.074

(57) ABSTRACT

An image processing apparatus includes: a photographing unit that includes a fisheye lens and that captures an image through the fisheye lens; a memory unit that stores three-dimensional (3D) model information for defining a 3D space; a light source number calculation unit that calculates a number of light sources that irradiate light onto the image captured by the photographing unit and that calculates light source coordinate information that indicates positions of the light sources corresponding to the number of light sources in the image; a light source information calculation unit that calculates parameters regarding the light source in a real space as light source information about parameters in the 3D space, based on the light source coordinate information; a 3D image writing unit that writes a 3D image, based on the 3D model information and the light source information; and a display unit that displays the 3D image, thereby obtaining information about a light source that exists in a real space and displaying an image that reflects information about the light source.

### CROSS-REFERENCE TO RELATED PATENT APPLICATIONS

This application claims the priority benefit of Japanese Patent Application No. 2009-293471, filed on Dec. 24, 2009, in the Japan Patent Office, and Korean Patent Application No. 10-2010-0127873, filed on Dec. 14, 2010, in the Korean Intellectual Property Office, the disclosures of which are incorporated herein in their entirety by reference.

### BACKGROUND

1. Field of the Invention

Embodiments relate to an image processing apparatus, an image processing method, and a recording medium.

2. Description of the Related Art

Many kinds of image processing technologies that are used to process images captured by cameras have been recently developed. In particular, technologies for preventing color information about different portions of an object from being incorrectly reproduced, according to a light source or illumination, have been developed.

### SUMMARY

Embodiments include an image processing apparatus that obtains information about a light source that exists in a real space and displays an image that reflects information about the light source, an image processing method, and a recording medium.

According to an embodiment, an image processing apparatus includes: a photographing unit that includes a fisheye lens and that captures an image through the fisheye lens; a memory unit that stores three-dimensional (3D) model information for defining a 3D space; a light source number calculation unit that calculates a number of light sources that irradiate light onto the image captured by the photographing unit and that calculates light source coordinate information that indicates positions of the light sources corresponding to the number of light sources in the image; a light source information calculation unit that calculates parameters regarding the light source in a real space as light source information including parameters in the 3D space, based on the light source coordinate information; a 3D image writing unit that writes a 3D image based on the 3D model information and the light source information; and a display unit that displays the 3D image.

The light source information calculation unit may calculate azimuth information, which indicates an azimuth of the light source in the real space, which is based on a position of the photographing unit due to projection conversion, as light source information, based on the light source coordinate information.

The light source information calculation unit may calculate position information, which indicates the position of the light source in the real space, as light source information, based on the azimuth information and a predetermined value.

The photographing unit may include at least two fisheye lenses and may capture an image through the at least two fisheye lenses, and the light source number calculation unit may calculate the number of light sources and light source information regarding the image captured by the photographing unit, and the light source information calculation unit may calculate azimuth information regarding the image captured by the photographing unit and may calculate position information, which indicates positions of the light sources in the real space, as the light source information, based on the azimuth information.

The light source information calculation unit may calculate at least one of intensity and color of light generated by the light source as the light source information, based on the light source coordinate information.

The light source number calculation unit may detect a light source region that corresponds to the number of light sources from the image and may calculate positions of the light source regions in the image as light source region coordinate information, and the light source information calculation unit may calculate diffusion of light generated by the light source as the light source information, based on the light source region coordinate information calculated by the light source number calculation unit.

The light source information calculation unit may approximate the light source region as two vectors based on the light source region coordinate information calculated by the light source number calculation unit and may calculate diffusion of light as the light source information by using the two vectors.

The light source information calculation unit may calculate at least one of intensity and color of ambient light in the real space as ambient light information including parameters in the 3D space based on the light source coordinate information calculated by the light source number calculation unit, and the 3D image writing unit may specify object color in the 3D space based on the ambient light information calculated by the light source information calculation unit and may write a 3D image having the object color.

The 3D image writing unit may calculate directions and a number of shadows formed in the 3D space based on the light source information calculated by the light source information calculation unit and the 3D model information stored by the memory unit, may specify a shadow region, based on the directions and number of the shadows, and may write a 3D image including a shadow in the shadow region.

The 3D image writing unit may specify a half shadow region formed in the 3D space, based on the position information calculated by the light source information calculation unit, as the light source information and the 3D model information stored by the memory unit and may write a 3D image including a half shadow in the half shadow region.

The light source information calculation unit may determine whether current light source information has changed compared to previous light source information that is used before the 3D image is written, and if it is determined by the light source information calculation unit that the current light source information has changed from the previous light source information, the 3D image writing unit may rewrite the 3D image, and the display unit may redisplay the 3D image that is rewritten by the 3D image writing unit.

The photographing unit may capture an image by receiving light from outside of the image processing apparatus through the fisheye lens.

According to another embodiment, an image processing method includes: capturing an image through a fisheye lens; calculating a number of light sources that irradiate light onto the image captured by the photographing unit and calculating light source coordinate information that indicates positions of the light sources corresponding to the number of light sources in the image; calculating parameters regarding the light source in a real space as light source information including parameters in a three-dimensional (3D) space, based on the light source coordinate information; writing a 3D image based on 3D model information for defining the 3D space, which is already stored, and the light source information; and displaying the 3D image.

According to another embodiment, a non-transitory computer-readable storage medium has stored thereon a program executable by a processor for performing the image processing method.

### BRIEF DESCRIPTION OF THE DRAWINGS

The above and other features and advantages will become more apparent by describing in detail exemplary embodiments with reference to the attached drawings in which:

FIG. 1 is a schematic view of an image processing apparatus, according to an embodiment;

FIG. 2 is a block diagram for illustrating a functional configuration of the image processing apparatus illustrated in FIG. 1, according to an embodiment;

FIG. 3 illustrates a function of a light source number calculation unit illustrated in FIG. 2, according to an embodiment;

FIG. 4 illustrates a function of a light source information calculation unit illustrated in FIG. 2, according to an embodiment;

FIG. 5A illustrates a display example of an image processed by the image processing apparatus illustrated in FIG. 1, according to an embodiment;

FIG. 5B illustrates a display example of an image processed by a conventional image processing apparatus;

FIG. 6A illustrates a display example of an image processed by the image processing apparatus illustrated in FIG. 1, according to another embodiment;

FIG. 6B illustrates a display example of an image processed by the image processing apparatus illustrated in FIG. 1, according to another embodiment;

FIG. 6C illustrates a display example of an image processed by the image processing apparatus illustrated in FIG. 1, according to another embodiment;

FIG. 7 illustrates the case where the light source information calculation unit illustrated in FIG. 2 calculates an azimuth of a light source as light source information, according to an embodiment;

FIG. 8 illustrates a low angle and an azimuth angle that are used to calculate the azimuth of the light source, according to an embodiment; and

FIG. 9 illustrates the case where the light source information calculation unit illustrated in FIG. 2 calculates a position of the light source as light source information, according to an embodiment.

### DETAILED DESCRIPTION

Particular embodiments will be illustrated in the drawings and described in detail in the written description, although various changes and numerous embodiments are allowed within the spirit and scope of the invention as defined by the following claims. The particular embodiments illustrated are not to be construed as limiting to particular modes of practice, and it is to be appreciated that all changes, equivalents, and substitutes that do not depart from the spirit and technical scope of the invention are encompassed therein. In the description, certain detailed explanations of related art are omitted when it is deemed that they may unnecessarily obscure the essence of the invention.

While such terms as “first,” “second,” etc., may be used to describe various components, such components must not be limited to the above terms. The above terms are used only to distinguish one component from another.

The terms used in the specification are merely used to describe particular embodiments, and are not intended to be limiting. An expression used in the singular encompasses the expression of the plural, unless it has a clearly different meaning in the context. In the specification, it is to be understood that terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

Certain embodiments will be described below in more detail with reference to the accompanying drawings. Those components that are the same or are in correspondence are given the same reference numeral regardless of the figure number, and redundant explanations are omitted.

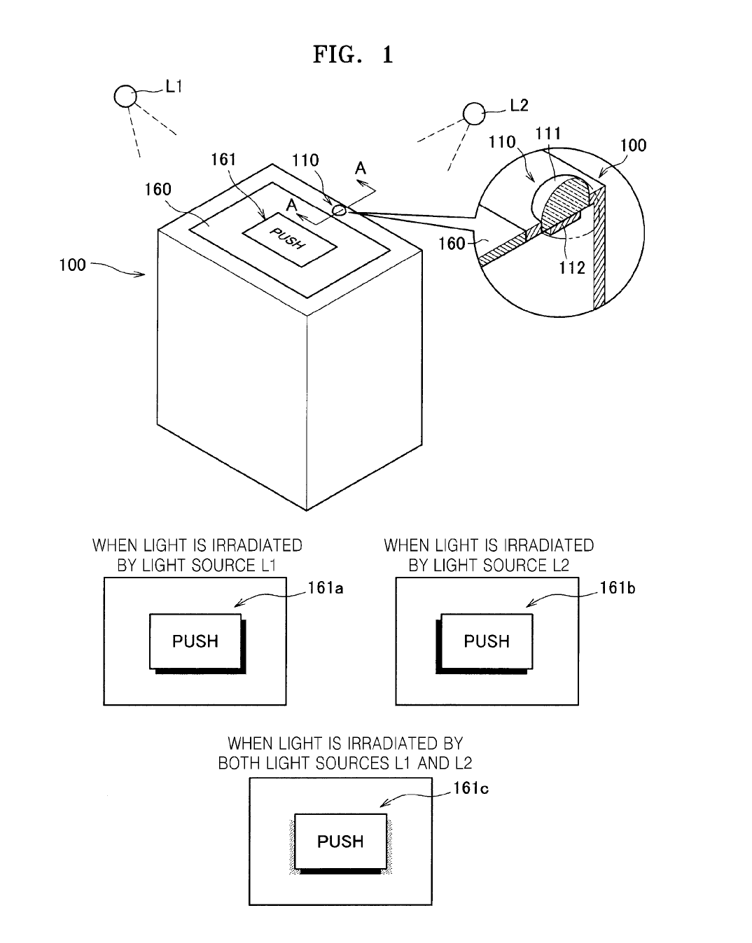

FIG. 1 is a schematic view of an image processing apparatus 100, according to an embodiment.

As illustrated in FIG. 1, the image processing apparatus 100 according to the current embodiment includes at least a display unit 160. The display unit 160 displays an image processed by the image processing apparatus 100. For example, an object 161 which is used by a user to input manipulation information to the image processing apparatus 100, is displayed by the display unit 160, as illustrated in FIG. 1.

Light sources L1 and L2, for example, are disposed around the image processing apparatus 100. The object 161 displayed by the display unit 160 is irradiated by light generated by the light sources L1 and L2. In order to indicate a stereoscopic configuration of the object 161, light generated by the light source L1 may be irradiated onto the object 161 so that a shadow may be displayed on a lower right portion of the object 161 (see object 161a). The lower right portion of the object 161 in this case is disposed in an opposite direction to a direction in which the light source L1 exists relative to the object 161. Thus, the user may see a realistic image displayed by the image processing apparatus 100.

Similarly, light generated by the light source L2 may be irradiated onto the object 161 so that a shadow may be displayed on a lower left portion of the object 161 (see object 161b). The lower left portion of the object 161 in this case is disposed in an opposite direction to a direction in which the light source L2 exists relative to the object 161. In addition, light generated by the light sources L1 and L2 may be irradiated onto the object 161 so that shadows may be displayed on each of the lower right portion and the lower left portion of the object 161 (see object 161c). In particular, since both shadows overlap each other in a region that corresponds to the lower portion of the object 161, the region may be displayed as a comparatively dark shadow. In order to realize this, the image processing apparatus 100 according to the current embodiment includes a photographing unit 110. The photographing unit 110 includes at least a fisheye lens 111 and a photographing element 112. The photographing element 112 captures an image through the fisheye lens 111 by receiving light from the outside of the image processing apparatus 100. In the current embodiment, the fisheye lens 111 that is not a planar lens (hereinafter referred to as a general lens) is used as a lens used to capture an image. Since the viewing angle of the general lens is smaller than 180°, there is a possibility that a light source for generating light to be irradiated onto the object 161 may not converge within a shooting range. However, since the viewing angle of the fisheye lens 111 is 180°, the light source for generating light to be irradiated onto the object 161 may converge within the shooting range.

For example, information about ambient light to be irradiated onto the image processing apparatus 100 may be obtained using a light measuring device including an integrating sphere. However, information about a light source cannot be obtained using the light measuring device including the integrating sphere. Thus, a direction in which the above-mentioned shadow should be displayed, and the like cannot be recognized. However, in the current embodiment, since the image processing apparatus 100 may perform a photographing operation by using the fisheye lens 111, information about the light source may be obtained, and the direction in which the shadow should be displayed may be recognized. In addition, since the image processing apparatus 100 according to the current embodiment may obtain information about the light source, information about ambient light may also be obtained regardless of information about the light source.

In the current embodiment, an image captured by the photographing unit 110 including the fisheye lens 111 is processed so that information about the light source that exists in a real space may be obtained and an image that reflects information about the light source may be displayed. Thus, a more realistic image may be displayed to the user.

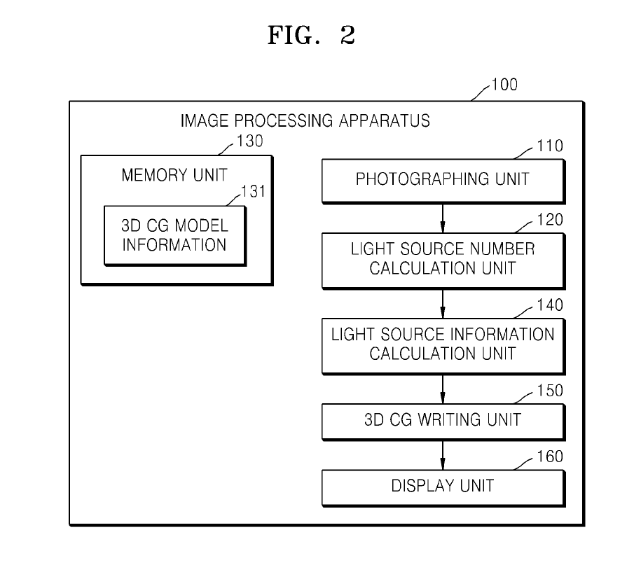

A functional configuration of the image processing apparatus 100 according to an embodiment will be described with reference to FIG. 2. FIG. 2 is a block diagram for illustrating the functional configuration of the image processing apparatus 100 illustrated in FIG. 1, according to an embodiment.

As illustrated in FIG. 2, the image processing apparatus 100 according to the current embodiment includes a photographing unit 110, a light source number calculation unit 120, a memory unit 130, a light source information calculation unit 140, a three-dimensional (3D) computer graphics (CG) writing unit 150, and a display unit 160.

The photographing unit 110 includes a fisheye lens 111 and captures an image by receiving light from the outside of the image processing apparatus 100 through the fisheye lens 111. The photographing unit 110 may include at least one or several fisheye lenses 111. The photographing unit 110 further includes a photographing element 112 that converts light incident from the outside of the image processing apparatus 100 through the fisheye lens 111 into an electrical signal.

The memory unit 130 stores 3D CG model information 131 for defining a 3D space. The 3D space is a virtual space displayed by the display unit 160 and is defined by an object having a shape, size, position, direction, color and the like. The object will be described later. The 3D CG model information 131 is an example of 3D model information. The memory unit 130 stores data, a program, or the like, which is used by elements of the image processing apparatus 100.

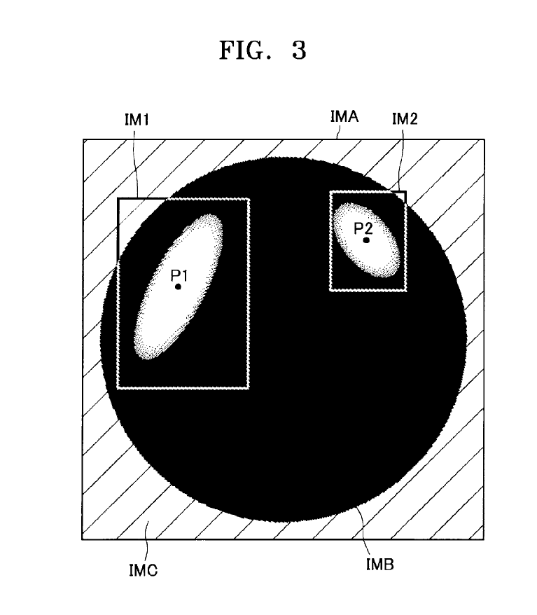

The light source number calculation unit 120 calculates a number of light sources that irradiate light onto an image captured by the photographing unit 110, thereby calculating light source coordinate information that indicates positions of light sources corresponding to the calculated number of light sources in the image. A function of the light source number calculation unit 120 will be described later in detail with reference to FIG. 3.

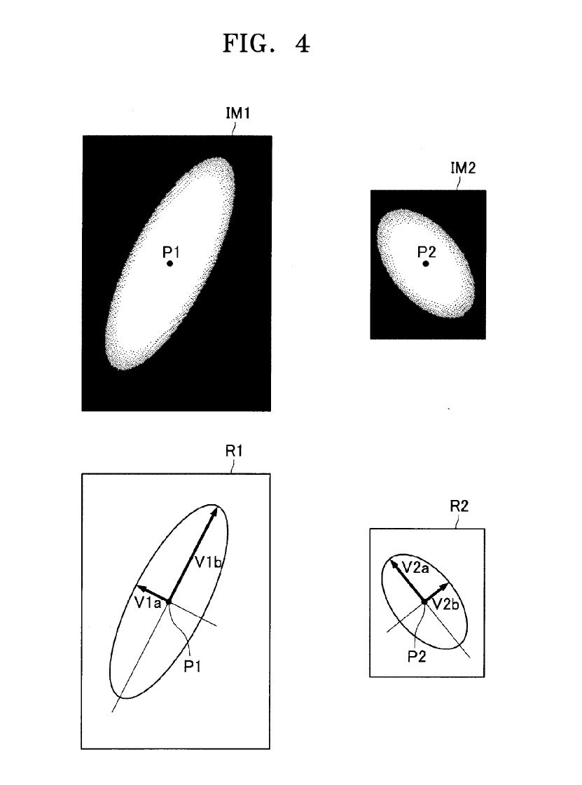

The light source information calculation unit 140 calculates parameters regarding a light source in a real space as light source information about parameters in a 3D space, based on the light source coordinate information that is calculated by the light source number calculation unit 120. A function of the light source information calculation unit 140 will be described later in detail with reference to FIG. 4.

The 3D CG writing unit 150 writes a 3D image, based on the 3D CG model information 131 that is stored by the memory unit 130 and light source information calculated by the light source information calculation unit 140. The 3D CG writing unit 150 serves as a 3D image writing unit. The display unit 160 displays the 3D image written by the 3D CG writing unit 150. The display unit 160 may display other information to be read by the image processing apparatus 100 if necessary. The display unit 160 may be a display device, for example.

Each of the elements of the image processing apparatus 100, such as the light source number calculation unit 120, the light source information calculation unit 140, and the 3D CG writing unit 150, includes a central processing unit (CPU) and a random access memory (RAM). Thus, the CPU develops a program stored in the memory unit 130 on the RAM and executes the program developed on the RAM so that functions of the light source number calculation unit 120, the light source information calculation unit 140, and the 3D CG writing unit 150 may be realized.

A function of the light source number calculation unit 120 according to an embodiment will be described with reference to FIG. 3. FIG. 3 illustrates the function of the light source number calculation unit 120 illustrated in FIG. 2, according to an embodiment.

As illustrated in FIG. 3, the photographing unit 110 may obtain an entire image IMA, for example, as the result of photographing. The entire image IMA includes an image IMB inside a lens and an image IMC outside the lens. The image IMB inside the lens is captured by receiving light from the outside of the image processing apparatus 100 through the fisheye lens 111, and the image IMC outside the lens is captured by the photographing unit 110 by receiving light without the fisheye lens 111. In the current embodiment, the image IMB inside the lens is usually used rather than the image IMC outside the lens. Furthermore, a light source position P1 corresponds to a portion in which the light source L1 is captured, and a light source position P2 corresponds to a portion in which the light source L2 is captured.

As described above, the light source number calculation unit 120 calculates the number of light sources that irradiate light onto the image IMB inside the lens, which is captured by the photographing unit 110. For example, the light source number calculation unit 120 sets a portion having brightness that is more than a predetermined value by using a histogram of the image IMB inside the lens as a light source candidate region. The predetermined value in this case may be stored by the memory unit 130, for example.

In the example of FIG. 3, two oval regions shown in the image IMB inside the lens are set as light source candidate regions. Since the light sources L1 and L2 are point light sources, the light source candidate regions are captured as the oval regions. The light source candidate regions may have shapes other than oval shapes. For example, when a light source is a rectangular fluorescent lamp, a light source candidate region may be rectangular. In this manner, the shape of the light source candidate region may be changed due to the shape of the light source.

Subsequently, the light source number calculation unit 120 detects an envelope in the light source candidate regions, and when a region surrounded by the envelope has an area that is more than a predetermined value, it is regarded that the light source candidate regions are light source regions and one light source exists in the light source regions. The predetermined value in this case may be stored by the memory unit 130, for example. The light source number calculation unit 120 detects a central position that is based on brightness in the light source regions, for example, as a light source position.

The envelope may be a line that surrounds the light source candidate regions and for example, the envelope may be a line for defining a region that is as small as possible so as to include the light source candidate regions. One light source is regarded to exist in a region that is determined to have an area that is more than a predetermined value so a to prevent a light source from being misunderstood to exist in a region that is captured due to simple light reflection.

In the example of FIG. 3, the light source number calculation unit 120 detects a rectangular region IM1 and a rectangular region IM2 as regions surrounded by the envelope, for example. The light source number calculation unit 120 determines that both the rectangular region IM1 and the rectangular region IM2 have an area that is more than a predetermined value and regards each of two oval regions as a light source region. In addition, the light source number calculation unit 120 calculates two light source regions as the light source position P1 and the light source position P2 by setting the center of two light source regions as a coordinate indicated in each light source coordinate information.

As described above, the light source number calculation unit 120 calculates the number of light sources that irradiate light onto the image IMB inside the lens captured by the photographing unit 110 and then calculates light source coordinate information that indicates positions of the light sources corresponding to the calculated number of light sources in the image IMB inside the lens. The number of light sources is calculated before the light source coordinate information is calculated, so as to regard a region including two light sources as one light source region and so as to prevent a central position that is based on brightness of the light source region from being misunderstood as a light source position.

A function of the light source information calculation unit 140 of the image processing apparatus 100 according to an embodiment will now be described with reference to FIG. 4. FIG. 4 illustrates the function of the light source information calculation unit 140 illustrated in FIG. 2, according to an embodiment.

As described above, the light source information calculation unit 140 calculates parameters regarding a light source in a real space as light source information about parameters in a 3D space, based on light source coordinate information calculated by the light source number calculation unit 120. In the example of FIG. 3, the light source number calculation unit 120 calculates the light source position P1 and the light source position P2 as a light source coordinate in the image IMB inside the lens. In the example of FIG. 4, the light source information calculation unit 140 calculates parameters regarding the light source L1 and the light source L2 in a real space as light source information about parameters in a 3D space, based on the light source position P1 and the light source position P2 in the image IMB inside the lens. There are several parameters regarding a light source in a real space, such as the azimuth and position of the light source, and the intensity, color, and diffusion of light generated by the light source. The light source information calculation unit 140 calculates the parameters in each rectangular region (rectangular region IM1 or IM2).

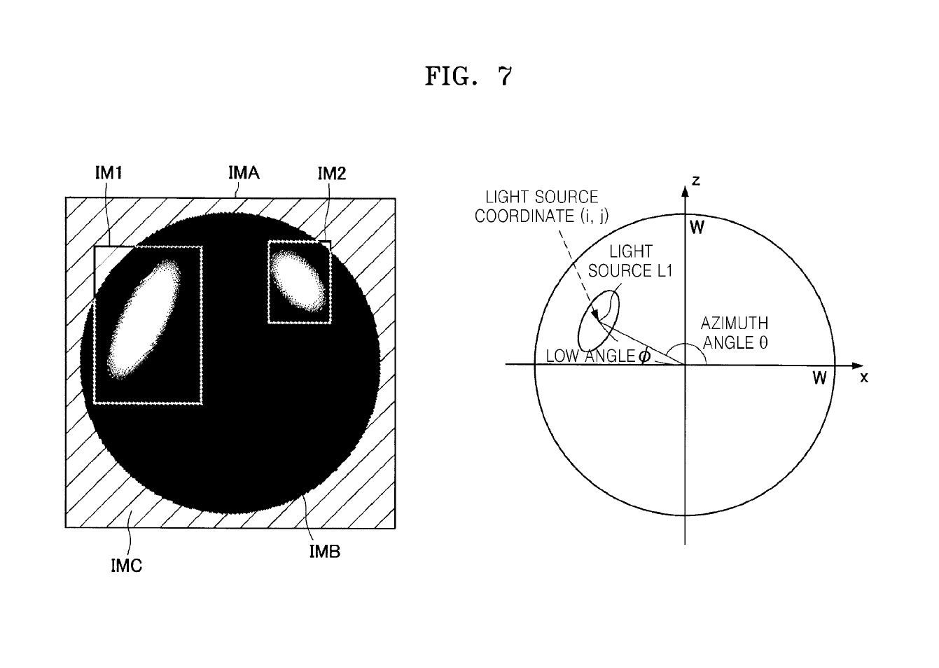

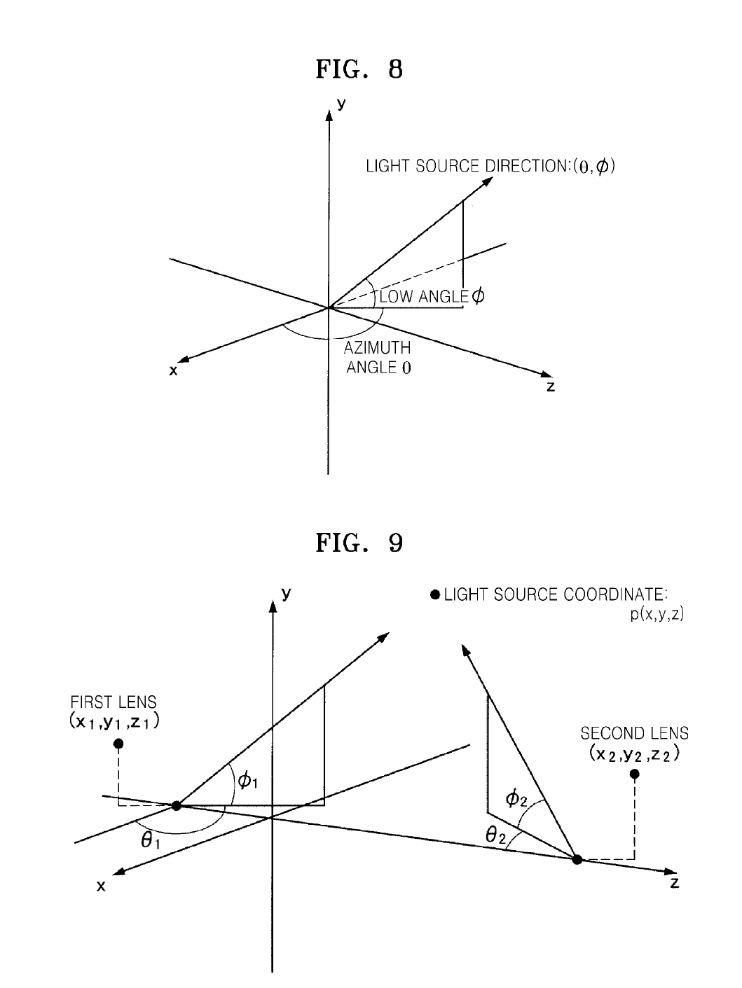

The light source information calculation unit 140 calculates azimuth information, which indicates the azimuth of the light source in a real space, based on the position of the photographing unit 110 due to projection conversion, as light source information based on light source coordinate information calculated by the light source number calculation unit 120, for example. A method of calculating azimuth information will be described later with reference to FIGS. 7 and 8. In addition, the light source information calculation unit 140 may calculate position information that indicates the position of the light source in a real space as light source information. There are several methods of calculating position information of a light source, such as a method of calculating information about the position of a light source, based on azimuth information and a predetermined value, a method of calculating position information of a light source by using several fisheye lenses and the like. The former will be described later with reference to FIGS. 7 and 8. The latter will be described later with reference to FIG. 9.

When positions of several light sources are calculated by the light source information calculation unit 140, the 3D CG writing unit 150 may generate a 3D image including a half shadow, based on the positions of several light sources. The half shadow is formed because light generated by some light sources does not entirely reach an object. More specifically, the 3D CG writing unit 150 specifies a half shadow region formed in the 3D space, based on position information calculated by the light source information calculation unit 140, as light source information and 3D model information that is stored by the memory unit 130 and writes a 3D image including a half shadow in a predetermined half shadow region.

The light source information calculation unit 140 may also calculate light source information by setting at least one of intensity and color of light that is generated by a light source, based on light source coordinate information calculated by the light source number calculation unit 120, as light source information, and by adding the at least one of intensity and color of light to the azimuth information. The light source information calculation unit 140 calculates light source information based on the pixel value of the light source position P1 or P2 and the exposure value of the photographing unit 110 as intensity of a light source, for example. The pixel value of the light source position P1 or P2 is calculated using an operation using three RGB colors of the light source position P1 or P2. The exposure value of the photographing unit 110 indicates the degree of exposure that is defined by an iris value, an exposure time or a shutter speed. In addition, the light source information calculation unit 140 calculates light source information, based on RGB colors of the light source position P1 or P2, as color of a light source, for example.

The light source information calculation unit 140 may calculate light source information by adding diffusion of light generated by a light source to azimuth information as light source information, based on the light source region coordinate information calculated by the light source number calculation unit 120. More specifically, the light source information calculation unit 140 may approximate a light source region as two vectors, based on the light source region coordinate information calculated by the light source number calculation unit 120, for example, and may calculate diffusion of light as the light source information by using the two vectors. In the example of FIG. 4, the light source information calculation unit 140 may approximate a short axis of a light source region R1 that exists in the rectangular region IM1 as a vector V1a and a long axis of the light source region R1 as a vector V1b and may approximate a long axis of a light source region R2 that exists in the rectangular region IM2 as a vector V2a and a short axis of the light source region R2 as a vector V2b. However, a method of approximating a light source region as two vectors is not particularly limited. For example, when the light source region is rectangular, the light source information calculation unit 140 may approximate a length and breadth of a rectangle as two vectors. In addition, the light source information calculation unit 140 may approximate the long axis, short axis and length and breadth of the rectangle as vectors that are multiplied by a predetermined integer as well as approximating them as simple vectors.

The light source information calculation unit 140 may further calculate at least one of intensity and color of ambient light in a real space as ambient light information about parameters in a 3D space, based on light source coordinate information calculated by the light source number calculation unit 120. The light source information calculation unit 140 may calculate intensity of ambient light in a real space, based on a pixel value and an exposure value of a region that does not belong to the rectangular region IM1 or IM2 of the image IMB inside the lens, for example.

In addition, the light source information calculation unit 140 may calculate a color of ambient light in a real space, based on an RGB color of the region that does not belong to the rectangular region IM1 or IM2 of the image IMB inside the lens, for example. The 3D CG writing unit 150 specifies color of an object in the 3D space, based on ambient light information calculated by the light source information calculation unit 140, and writes a 3D image having specific object color. The ambient light information is a factor that greatly contributes to the brightness of a portion that light generated by a light source does not reach. The portion that light generated by the light source does not reach is a portion in which a shadow that will be described below is formed.

In the current embodiment, the image processing apparatus 100 may obtain information about a light source from an image captured by the fisheye lens 111 and thus may obtain information about ambient light that is different from the information about the light source. For example, when information about light that will be incident on an integrating sphere is obtained using the integrating sphere or the like, the information about the light source and the information about ambient light may not be differentiated from each other from the information obtained.

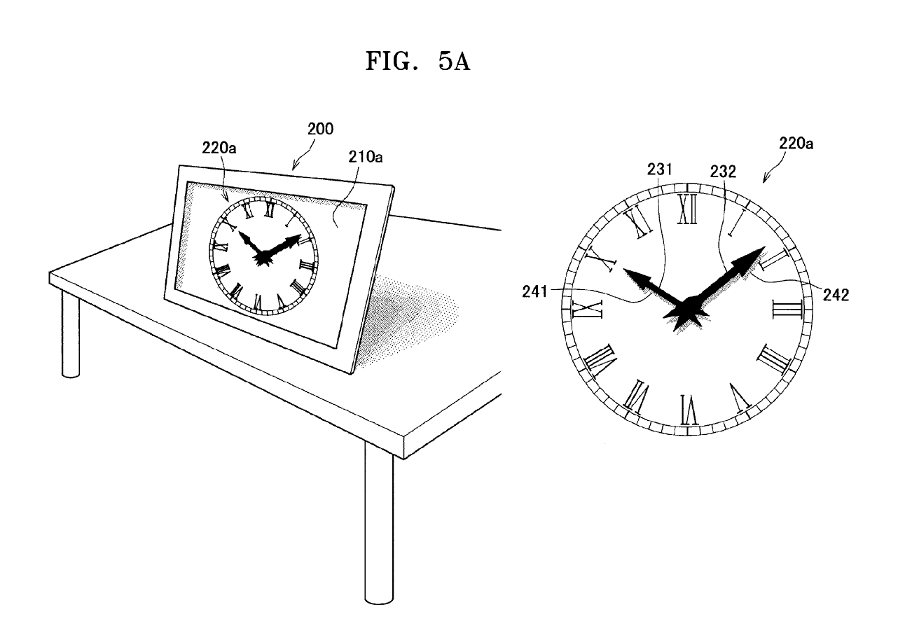

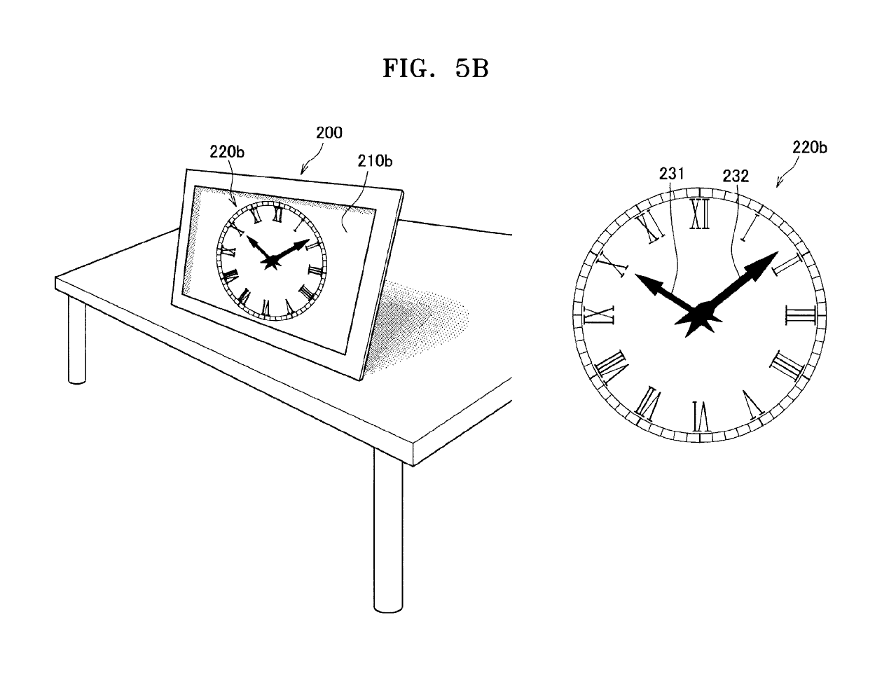

A case where one light source exists as a display example of an image processed by the image processing apparatus 100 according to an embodiment will be described with reference to FIG. 5A. FIG. 5A illustrates a display example of an image processed by the image processing apparatus 100 illustrated in FIG. 1, according to an embodiment.

As illustrated in FIG. 5A, an object 220a is included in a screen 210a displayed by an image processing apparatus 200 as an example of the image processing apparatus 100. The object 220a is defined by the 3D CG model information 131 and is displayed on the display unit 160 as a 3D image. As illustrated in FIG. 5A, an object 231 and an object 232 each having a height in a direction perpendicular to the screen 210a are included in the object 220a. In such a case, information about a light source for generating light to be irradiated onto the image processing apparatus 200 is obtained by the light source information calculation unit 140 of the image processing apparatus 200. In addition, a shadow 241 and a shadow 242 that are based on the information about the light source are displayed by the 3D CG writing unit 150 of the image processing apparatus 200 on the screen 210a. As such, when the image processing apparatus 200 is installed indoors, the screen 210a that is more suitable considering the surrounding environment of the image processing apparatus 200 may be displayed.

More specifically, the 3D CG writing unit 150 of the image processing apparatus 200 calculates directions and the number of shadows formed in the 3D space, based on the light source information calculated by the light source information calculation unit 140 and the 3D CG model information 131 stored by the memory unit 130. The 3D CG writing unit 150 specifies a shadow region, based on the calculated directions and number of the shadows, and writes a 3D image including a shadow in the specified shadow region. The display unit 160 displays the 3D image generated by the 3D CG writing unit 150.

Recently, portable displays, such as digital photo frames, smart phones, tablet personal computers (PCs) and the like, have become widely used. In the portable displays, since their environment is often changed, it is particularly useful if they can adapt to a changing light source. In addition, an image of a sample of an article to be sold is displayed in a stereoscopic manner and includes a shadow generated by a light source so that a difference between an impression of an article to be purchased an impression of a sample of the article may be reduced.

In addition, the image processing apparatus 200 may quickly calculate the information about the light source when an installation environment is changed and may immediately change an image to be displayed into a 3D image adapted to the environment after a change. More specifically, the light source information calculation unit 140 determines whether current light source information is changed compared to previous light source information that is used before the 3D image is written. When it is determined by the light source information calculation unit 140 that the current light source information is changed from the previous light source information, the 3D CG writing unit 150 rewrites the 3D image, and the display unit 160 redisplays the 3D image that is rewritten by the 3D CG writing unit 150.

A case where one light source exists as a display example of an image processed by a conventional image processing apparatus will be described with reference to FIG. 5B. FIG. 5B illustrates a display example of an image processed by the conventional image processing apparatus.

As illustrated in FIG. 5B, the conventional image processing apparatus displays a screen 210b including an object 220b. The object 220b includes an object 231 and an object 232. However, shadows formed due to the existence of the objects 231 and 232 are not particularly shown on the object 220b.

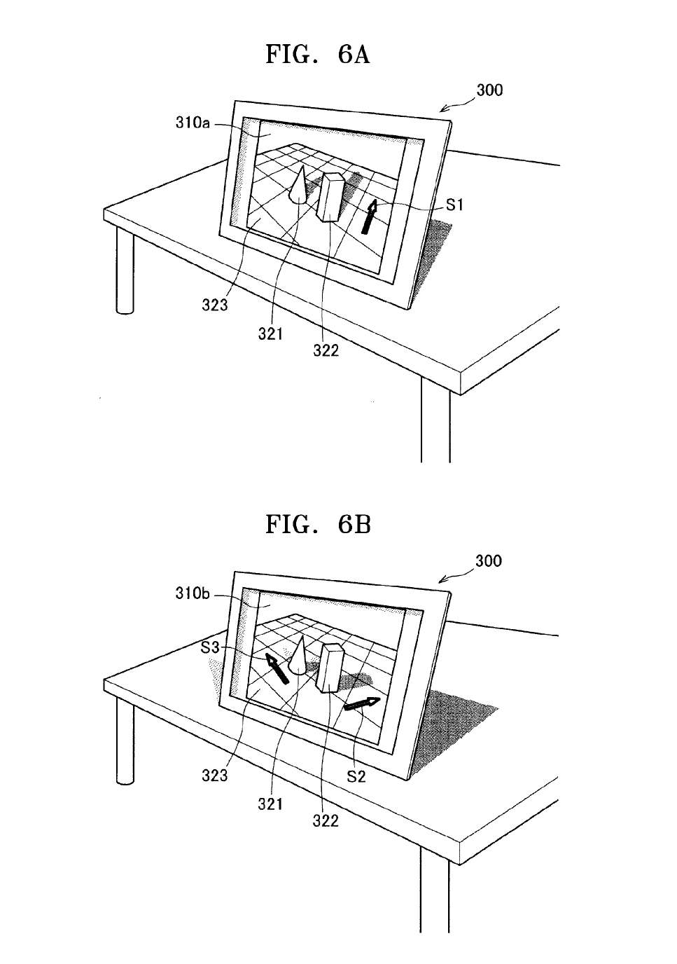

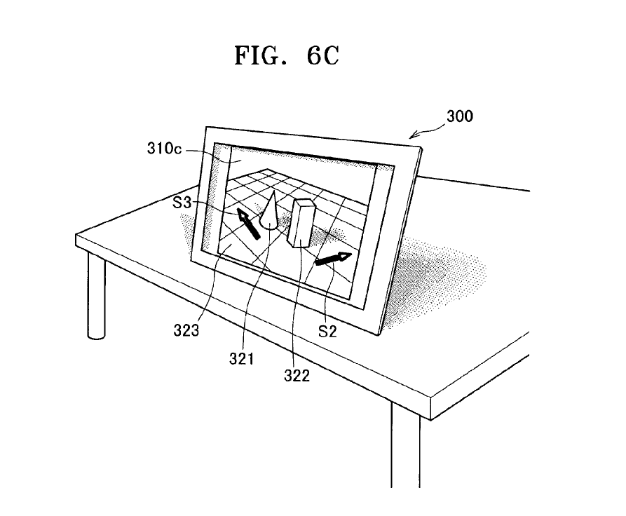

A case where one point light source exists as a display example of an image processed by an image processing apparatus according to an embodiment will be described with reference to FIG. 6A. FIG. 6A illustrates a display example of an image processed by the image processing apparatus 100 illustrated in FIG. 1, according to another embodiment.

As illustrated in FIG. 6A, an image processing apparatus 300 as an example of the image processing apparatus 100 displays a screen 310a. The screen 310a includes an object 321, an object 322, and an object 323. Information about a light source is obtained by the light source information calculation unit 140 of the image processing apparatus 300, and a 3D image including a shadow in a direction S1, based on the objects 321 and 322, is generated by the 3D CG writing unit 150 of the image processing apparatus 300. The 3D image is displayed by the display unit 160 of the image processing apparatus 300. Here, the case where a one point light source exists is illustrated.

A case where two point light sources exist as a display example of an image processed by an image processing apparatus according to an embodiment will be described with reference to FIG. 6B. FIG. 6B illustrates a display example of an image processed by the image processing apparatus 100 illustrated in FIG. 1, according to another embodiment.

As illustrated in FIG. 6B, an image processing apparatus 300, as an example of the image processing apparatus 100, displays a screen 310b. The screen 310b includes an object 321, an object 322, and an object 323. Information about a light source is obtained by the light source information calculation unit 140 of the image processing apparatus 300, and a 3D image including a shadow in directions S2 and S3, based on the objects 321 and 322, is generated by the 3D CG writing unit 150 of the image processing apparatus 300. The 3D image is displayed by the display unit 160 of the image processing apparatus 300. Here, the case where two point light sources exist is illustrated.

A case where a one point light source and a one surface light source exist as a display example of an image processed by an image processing apparatus according to an embodiment will be described with reference to FIG. 6C. FIG. 6C illustrates a display example of an image processed by the image processing apparatus 100 illustrated in FIG. 1, according to another embodiment.

As illustrated in FIG. 6C, an image processing apparatus 300 as an example of the image processing apparatus 100 displays a screen 310c. The screen 310c includes an object 321, an object 322, and an object 323. Information about a light source is obtained by the light source information calculation unit 140 of the image processing apparatus 300, and a 3D image including a shadow in directions S2 and S3, based on the objects 321 and 322, is generated by the 3D CG writing unit 150 of the image processing apparatus 300. The 3D image is displayed by the display unit 160 of the image processing apparatus 300. Here, the case where the one point light source and the one surface light source exist is illustrated. Since light is irradiated by the surface light source, a shadow formed in the direction S2 has a gentle border. This is because information that indicates diffusion of light generated by the light source is obtained by the light source information calculation unit 140 of the image processing apparatus 300 as light source information and the 3D CG writing unit 150 of the image processing apparatus 300 writes a 3D image considering an increase in light sources.

A method of calculating an azimuth of a light source as light source information by using a light source information calculation unit of an image processing apparatus according to an embodiment will be described with reference to FIG. 7. FIG. 7 illustrates the case where the light source information calculation unit 140 illustrated in FIG. 2 calculates the azimuth of the light source as light source information, according to an embodiment. Here, it is assumed that one fisheye lens 111 is used in the image processing apparatus 100.

A light source coordinate (i, j) of the light source in the image IMB inside the lens is obtained as a two-dimensional (2D) coordinate. The fisheye lens 111 projects light on the image IMB inside the lens by using equidistant cylindrical projection that is one equidistant projection method, and a length having an angle of 90° in the image IMB inside the lens is referred to as W. In this case, the relationship between the light source coordinate (i, j) and the azimuth of the light source (azimuth angle, low angle)=(θ, φ) is represented by Equation 1. Definitions of the low angle and the azimuth angle are illustrated in FIG. 8.

$$\{ \begin{matrix}θ = {Tan}^{- 1} ( \frac{j}{i} ) \\ φ = \frac{π}{2} ( 1 - \frac{\sqrt{{i}^{2} + {j}^{2}}}{W} )\end{matrix} \qquad ( 1 )$$

When the 3D CG writing unit 150 does not write a half shadow in 3D CG, a shadow may be written by using the direction of the light source even though the position of the light source cannot be recognized. When the 3D CG writing unit 150 writes the half shadow, an appropriate radius R is set, and a light source coordinate (x, y, z) that is obtained by Equation 2 is used. The radius R may be stored by the memory unit 130, for example, and may be appropriately changed by a manager who manages the image processing apparatus 100.

$$\{ \begin{matrix}x = R \cdot cos φ \cdot sin θ \\ y = R \cdot sin φ \\ z = R \cdot cos φ \cdot cos θ\end{matrix} \qquad ( 2 )$$

A low angle and an azimuth angle that are used to calculate the azimuth of a light source will be described with reference to FIG. 8. FIG. 8 illustrates the low angle and the azimuth angle that are used to calculate the azimuth of the light source.

The low angle and the azimuth angle that are used to calculate the direction of the light source are defined by the image processing apparatus 100, as illustrated in FIG. 8, for example.

A method of calculating the position of a light source as light source information by using a light source information calculation unit of an image processing apparatus according to an embodiment will be described with reference to FIG. 9.

FIG. 9 illustrates the case where the light source information calculation unit 140 illustrated in FIG. 2 calculates a position of the light source as light source information, according to an embodiment. Here, it is assumed that several fisheye lenses 111 are used in the image processing apparatus 100.

When there are several fisheye lenses 111, a light source coordinate may be obtained even though the radius R is not assumed. Simply, there are two fisheye lenses 111, and coordinates (x1, y1, z1) and (x2, y2, z2) in each real space are already recognized by the image processing apparatus 100, and azimuths (θ1, φ1) and (θ2, φ2) of the light source in each of the fisheye lens 111 are calculated by the image processing apparatus 100. In this case, direction vectors (v1x, v1y, v1z) and (v2x, v2y, v2z) of the light source are expressed by Equation 3:

$$( \begin{matrix}{v}_{x}^{1} \\ {v}_{y}^{1} \\ {v}_{z}^{1}\end{matrix} ) = ( \begin{matrix}cos {φ}_{1} \cdot sin {θ}_{1} \\ sin {φ}_{1} \\ cos {φ}_{1} \cdot cos {θ}_{1}\end{matrix} ) \\ ( \begin{matrix}{v}_{x}^{2} \\ {v}_{y}^{2} \\ {v}_{z}^{2}\end{matrix} ) = ( \begin{matrix}cos {φ}_{2} \cdot sin {θ}_{2} \\ sin {φ}_{2} \\ cos {φ}_{2} \cdot cos {θ}_{2}\end{matrix} ) . \qquad ( 3 )$$

By using Equation 3, the coordinate (x, y, z) of the light source is obtained by using Equation 4:

$$x = \frac{s \cdot {v}_{x}^{2} \cdot {x}_{1} - t \cdot {v}_{x}^{1} \cdot {x}_{2}}{s \cdot {v}_{x}^{2} - t \cdot {v}_{x}^{1}} \\ y = \frac{s \cdot {v}_{y}^{2} \cdot {y}_{1} - t \cdot {v}_{y}^{1} \cdot {y}_{2}}{s \cdot {v}_{y}^{2} - t \cdot {v}_{y}^{1}} \\ z = \frac{s \cdot {v}_{z}^{2} \cdot {z}_{1} - t \cdot {v}_{z}^{1} \cdot {z}_{2}}{s \cdot {v}_{z}^{2} - t \cdot {v}_{z}^{1}} \qquad ( 4 )$$

where s and t are parameters and are defined by Equation 5 († represents a Moore-Penrose generalized inverse matrix). Here, the number of light sources may be n (where n is equal to or greater than 3).

$$( \begin{matrix}t \\ s\end{matrix} ) = {( \begin{matrix}{v}_{x}^{1} & {v}_{x}^{2} \\ {v}_{y}^{1} & {v}_{y}^{2} \\ {v}_{z}^{1} & {v}_{z}^{2}\end{matrix} )}^{†} ( \begin{matrix}{x}_{2} - {x}_{1} \\ {y}_{2} - {y}_{1} \\ {z}_{2} - {z}_{1}\end{matrix} ) . \qquad ( 5 )$$

As described above, information about a light source that exists in a real space may be obtained, and an image that reflects information about the light source may be displayed. Thus, the user may see a realistic image displayed by the image processing apparatus 100.

The device described herein may comprise a processor, a memory for storing program data and executing it, a permanent storage device such as a disk drive, a communications port for handling communications with external devices, and user interface devices, including a display, keys, etc. When software modules are involved, these software modules may be stored as program instructions or computer readable codes executable on the processor on a non-transitory computer-readable media such as read-only memory (ROM), random-access memory (RAM), CD-ROMs, magnetic tapes, floppy disks, and optical data storage devices. The computer readable recording medium may also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that may be executed on one or more processors. Furthermore, the invention could employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention.

What is claimed is:

1. An image processing apparatus comprising:
a photographing unit comprising a fisheye lens that captures an image through the fisheye lens;
a memory unit that stores three-dimensional (3D) model information for defining a 3D space;
a light source number calculation unit that calculates a number of light sources that irradiate light onto the image captured by the photographing unit and that calculates light source coordinate information that indicates positions of the light sources corresponding to the number of light sources in the image;
a light source information calculation unit that calculates parameters regarding the light source in a real space as light source information comprising parameters in the 3D space, based on the light source coordinate information;
a 3D image writing unit that writes a 3D image based on the 3D model information and the light source information; and
a display unit that displays the 3D image.

2. The image processing apparatus of claim 1, wherein the light source information calculation unit calculates azimuth information, which indicates an azimuth of the light source in the real space, which is based on a position of the photographing unit due to projection conversion, as light source information, based on the light source coordinate information.

3. The image processing apparatus of claim 2, wherein the light source information calculation unit calculates position information, which indicates the position of the light source in the real space, as light source information, based on the azimuth information and a predetermined value.

4. The image processing apparatus of claim 2, wherein the photographing unit comprises at least two fisheye lenses and captures an image through the at least two fisheye lenses, and the light source number calculation unit calculates the number of light sources and light source information regarding the image captured by the photographing unit, and the light source information calculation unit calculates azimuth information regarding the image captured by the photographing unit and calculates position information, which indicates positions of the light sources in the real space, as the light source information, based on the azimuth information.

5. The image processing apparatus of claim 2, wherein the light source information calculation unit calculates at least one of intensity and color of light generated by the light source as the light source information, based on the light source coordinate information.

6. The image processing apparatus of claim 2, wherein the light source number calculation unit detects a light source region that corresponds to the number of light sources from the image and calculates positions of the light source regions in the image as light source region coordinate information, and the light source information calculation unit calculates diffusion of light generated by the light source as the light source information, based on the light source region coordinate information calculated by the light source number calculation unit.

7. The image processing apparatus of claim 6, wherein the light source information calculation unit approximates the light source region as two vectors based on the light source region coordinate information calculated by the light source number calculation unit and calculates diffusion of light as the light source information by using the two vectors.

8. The image processing apparatus of claim 1, wherein the light source information calculation unit calculates at least one of intensity and color of ambient light in the real space as ambient light information comprising parameters in the 3D space based on the light source coordinate information calculated by the light source number calculation unit, and the 3D image writing unit specifies object color in the 3D space based on the ambient light information calculated by the light source information calculation unit and writes a 3D image having the object color.

9. The image processing apparatus of claim 1, wherein the 3D image writing unit calculates directions and a number of shadows formed in the 3D space based on the light source information calculated by the light source information calculation unit and the 3D model information stored by the memory unit, specifies a shadow region, based on the directions and number of the shadows, and writes a 3D image including a shadow in the shadow region.

10. The image processing apparatus of claim 3, wherein the 3D image writing unit specifies a half shadow region formed in the 3D space, based on the position information calculated by the light source information calculation unit, as the light source information and the 3D model information stored by the memory unit and writes a 3D image including a half shadow in the half shadow region.

11. The image processing apparatus of claim 1, wherein the light source information calculation unit determines whether current light source information has changed compared to previous light source information that is used before the 3D image is written, and if it is determined by the light source information calculation unit that the current light source information has changed from the previous light source information, the 3D image writing unit rewrites the 3D image, and the display unit redisplays the 3D image that is rewritten by the 3D image writing unit.

12. The image processing apparatus of claim 1, wherein the photographing unit captures an image by receiving light from outside of the image processing apparatus through the fisheye lens.

13. An image processing method comprising:
capturing an image through a fisheye lens;
calculating a number of light sources that irradiate light onto the image captured by the photographing unit and calculating light source coordinate information that indicates positions of the light sources corresponding to the number of light sources in the image;
calculating parameters regarding the light source in a real space as light source information comprising parameters in a three-dimensional (3D) space, based on the light source coordinate information;
writing a 3D image based on 3D model information for defining the 3D space, which is already stored, and the light source information; and
displaying the 3D image.

14. A non-transitory computer-readable storage medium has stored thereon a computer program executable by a processor for performing a method, the method comprising:
capturing an image through a fisheye lens;
calculating a number of light sources that irradiate light onto the image captured by the photographing unit and calculating light source coordinate information that indicates positions of the light sources corresponding to the number of light sources in the image;
calculating parameters regarding the light source in a real space as light source information comprising parameters in a three-dimensional (3D) space, based on the light source coordinate information;
writing a 3D image based on 3D model information for defining the 3D space, which is already stored, and the light source information; and
displaying the 3D image.
